(19) United States
(12) Patent Application Publication
(10) Pub. No.: US 2025/0269999 A1
(43) Pub. Date: Aug. 28, 2025

(54) PLASTIC CONTAINER AND METHOD

(71) Applicant: Plastipak Packaging, Inc., Plymouth, MI (US)

(72) Inventors: Sam Van Dijck, Hoogstraten (BE); Miguel Vieira, Vilvoorde (BE)

(21) Appl. No.: 19/061,010

(22) Filed: Feb. 24, 2025

Related U.S. Application Data
(60) Provisional application No. 63/556,765, filed on Feb. 22, 2024.

(51) Int. Cl. B65D 1/10; B29C 45/00; B29K 23/00

(52) U.S. Cl. CPC B65D 1/10; B29C 45/0001; B29K 2023/065

(57) ABSTRACT

An injection molded plastic container or jar is disclosed. In embodiments, the container or jar is formed via injection molding and may be suitable to hold hot-filled or pasteurized contents. The plastic container or jar includes a base portion, a body portion, and a neck portion. In embodiments, the body portion and the base portion are not biaxially oriented, and a wall thickness of the neck portion, excluding threading or a formation, is less than a minimum wall thickness of the base portion. The body portion may include a plurality of panels and/or may have a non-circular cross section. In embodiments, the base portion may have an outer peripheral edge portion and a central base portion disposed inwardly of the outer peripheral edge portion, and the base portion may have a varying wall thickness and a radiused segment disposed at or about the outer peripheral edge portion.

### CROSS-REFERENCE TO RELATED APPLICATIONS

This application claims the benefit of U.S. Provisional Application No. 63/556,765, filed on Feb. 22, 2024, the entire disclosure of which is incorporated herein by reference.

### TECHNICAL FIELD

The present disclosure generally relates to plastic containers or jars, including containers and jars suitable for holding cold, warm fill and refill, hot-filled, or pasteurized contents, as well as systems and methods for making plastic containers or jars.

### BACKGROUND

Plastic containers and jars are used to hold a variety of contents, Plastic jars are generally a type of plastic container that comprise rigid, cylindrical or slightly conical containers made of glass, ceramic, or plastic. Jars often have a wide mouth or opening that can be closed with a closure, such as, for example, a lid, screw cap, lug cap, cork stopper, roll-on cap, crimp-on cap, press-on cap, or other suitable means. Jars are commonly used for storing food items such as pickles, jams, and sauces. Jars also may be used for storing non-food items, such as cosmetics, medicines, and chemicals, Plastic containers and jars may be comprised of various polymers and may come in a variety of sizes, shapes, and configurations. Polyethylene terephthalate (PET) and high-density polyethylene (HDPE) are two materials commonly used for making plastic containers. In some circumstances PET and HDPE may be suitable as a glass alternative and may possibly hold hot-filled or pasteurized contents. However, the manufacturing of such containers typically involves heavy, or thick, wall thicknesses, and requires the use of blow molding.

Among other things, it may be desirable to provide a plastic container or jar that is injection molded, not blow molded (e.g., subject to biaxial orientation), and comprised of plastic (such as, without limitation, PET or HDPE) without necessarily requiring thick walls. It may further be desirable to provide injection molded plastic containers that, while capable of use for cold or warm-fill applications, can be suitable for holding hot-filled or pasteurized contents, may involve comparatively thinner wall portions (e.g., with respect to blow molded PET glass alternative containers), and/or may provide a weight reduction with respect to glass containers or jars, or plastic containers.

### SUMMARY

An injection molded plastic container or jar is disclosed. In embodiments, the container or jar may be formed via injection molding and may be suitable to hold hot-filled or pasteurized contents. The plastic container or jar includes a base portion, a body portion, and a neck portion. In embodiments, the body portion and the base portion are not biaxially oriented, and a wall thickness of the neck portion, excluding threading or a formation, is less than a minimum wall thickness of the base portion. The body portion may include a plurality of panels and/or may have a non-circular cross section. In embodiments, the base portion may have an outer peripheral edge portion and a central base portion disposed inwardly of the outer peripheral edge portion, and the base portion may have a varying wall thickness and a radiused segment disposed at or about the outer peripheral edge portion.

Aspects and features of the present disclosure may address one or more challenges associated with the current art.

### BRIEF DESCRIPTION OF THE DRAWINGS

Further advantages, features and details of the disclosure result from the following description of embodiments as well as from the drawings.

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a side view generally illustrating an embodiment of a plastic container according to teachings of the present disclosure;

FIG. 2 is a perspective view generally illustrating an embodiment of a plastic container, according to teachings of the present disclosure;

FIG. 3 is a perspective view generally illustrating an embodiment of a plastic container, according to teachings of the present disclosure, and depicting an embodiment of a neck finish;

FIG. 4 is a perspective view generally illustrating another embodiment of a plastic container, according to teachings of the present disclosure, and depicting a second embodiment of a neck finish;

FIG. 5 is a side view of the plastic container shown in FIG. 4;

FIG. 6 is a side cross-sectional view of the plastic container shown in FIG. 3;

FIG. 7 is a top sectional view taken along F-F of FIG. 6;

FIG. 8 is another side cross-sectional view of the plastic container shown in FIG. 3;

FIG. 9 is a bottom view of the plastic container shown in FIG. 3;

FIG. 10 is a side view representation of an embodiment of a plastic container according to teachings of the present disclosure;

FIG. 11 is a perspective view representation of an embodiment of a neck finish portion of a plastic container, including a region Z having an undercut, according to teachings of the present disclosure;

FIG. 12 is a perspective view of an embodiment of a neck finish portion of a plastic container according to teachings of the present disclosure;

FIG. 13 is a top view of the neck finish portion shown in FIG. 12;

FIGS. 14 and 15 are side views of the neck finish portion shown in FIG. 12;

FIG. 16 is a partial side cross-sectional view of neck finish portion shown in FIG. 12;

FIG. 17 is a side view of neck finish portion shown in FIG. 12;

FIG. 18 is side cross-sectional view of the section shown in FIG. 16;

FIG. 19 is a perspective view representation of an embodiment of a core cooling tube with a single channel according to teachings of the present disclosure;

FIG. 20 is a perspective view representation of an embodiment of a core cooling tube with multiple channels according to teachings of the present disclosure;

FIG. 21 generally illustrates a side cross-sectional view of a mold for forming a plastic container including a cavity plate;

FIGS. 22 and 23 generally illustrate enlarged section views of the portion identified in FIG. 21;

FIGS. 24 generally illustrates a perspective view of an embodiment of a base portion of a plastic container according to teachings of the present disclosure;

FIGS. 25A and 25B generally illustrate a cross sectional view and a side view representation of embodiments of a system associated with the transfer of an article;

FIGS. 26, 27, and 28 generally illustrate perspective views of other embodiments of plastic containers according to aspects or teachings of the present disclosure;

FIGS. 29 and 30 generally illustrate another embodiment of a plastic container according to aspects or teachings of the present disclosure, with FIG. 30 generally illustrating a wall thickness distribution in cross section;

FIGS. 31A, 31A, and 31C generally illustrate cross sectional views of a base portions of a plastic container;

FIG. 32 generally illustrates a bottom perspective view of a resultant plastic container;

FIG. 33 generally illustrates a cross section of embodiment of a system having a comparatively more extreme stretch robot tube insert;

FIG. 34 is a top view of a plastic container or jar that may be formed from a system such as shown in FIG. 33;

FIG. 35 is a side view of the container or jar generally shown in FIG. 34;

FIG. 36A is a perspective view of an embodiment of an injection molded plastic container including a plurality of panels separated by ribs;

FIG. 36B is a cross sectional view of an embodiment of an injection molded plastic container such as generally shown in FIG. 36A;

FIG. 37A is a table identifying wall thickness in several portions of an embodiment of an injection molded container having panels and ribs;

FIG. 37B is a partial cross sectional illustration of an embodiment of an injection molded plastic container and a base portion of a plastic container, along with a wall thickness plot for values associated with both a rib portion and a panel (or body portion);

FIG. 38 is a top view of an embodiment of a container or jar;

FIG. 39 is an illustration of a portion of a neck of a container or jar such as shown in FIG. 38;

FIG. 40 is a perspective view of a neck portion of a container or jar with threads; and FIG. 41 is a top view generally illustrating a neck portion of a container or jar.

### DETAILED DESCRIPTION

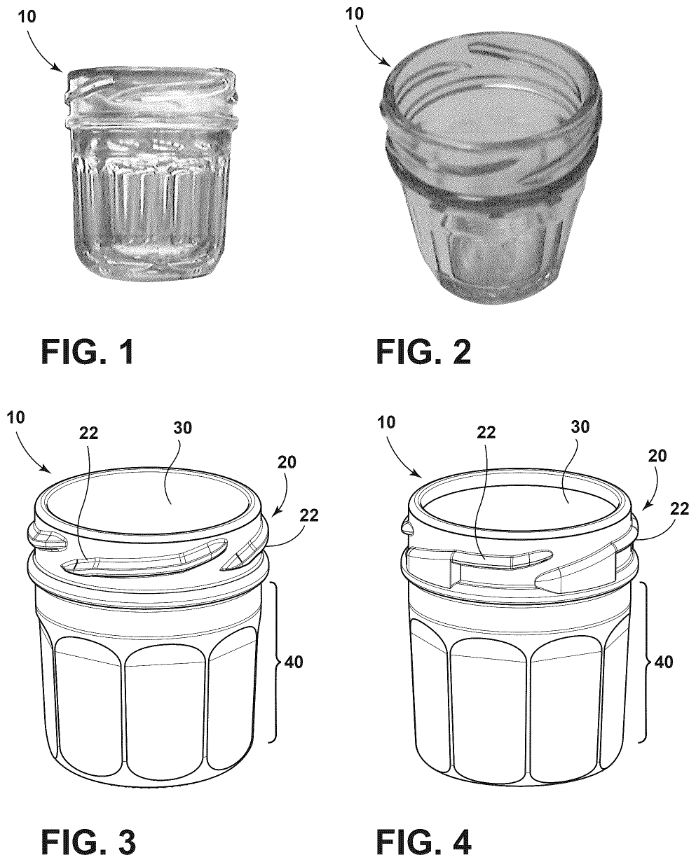

FIGS. 1 and 2 generally illustrate embodiments of a plastic container 10. Such plastic containers may, among other things, comprise jars or mini plastic jars. In embodiments, such plastic containers 10 may be comprised of a polymer or plastic material. For example and without limitation, in some embodiments such plastic containers or jars may be comprised of polyethylene terephthalate (PET), high-density polyethylene (HDPE), polyethylene furanoate (PEF), polyethylene terephthalate film (PETF), or polypropylene (PP). With some embodiments, a container may comprise poly cyclohexylenedimethylene terephthalate glycol-modified (PCT-G), polystyrene (PS), or other polymers or copolymers (such as Tritan™, a copolyester developed by Eastman Chemical Company) that may be used for making plastic containers suitable to hold contents, which may include hot-filled or pasteurized contents, and/or that may serve as alternatives materials for traditional glass packaging. With some embodiments, the plastic may comprise compostable and/or biodegradable material.

With embodiments, making a plastic container or jar that can hold cold, warm, hot-filled, and/or pasteurized contents can require the use of a material that can withstand high temperatures, Hot-filling may, for example and without limitation, involve contents having a temperature of commonly 60 C-105 C, and often 75 C-85 C. Pasteurization may involve low temperatures (e.g., 63 C), for a long time (e.g., 30 minutes); high temperature (e.g., 72 C), for a comparatively shorter time (e.g., 15 seconds); or ultra-high temperature (e.g., 135 C-150 C), for a comparatively very short period of time (e.g., 2-5 seconds). In embodiments, PET can be a highly suitable alternative for traditional glass packaging that can also withstand high temperatures. Among other things, PET may offer the visual allure of glass, while also being lightweight, shatter-resistant, and cost effective. The plastic or polymer may include, or may even be entirely comprised, of post-consumer recycled (PCR) plastic material, for example, recycled PET. It is noted that the weight of the container may be comparatively less (i.e., lighter) if a container is for cold-fill (non-hot-fill or non-pasteurized) applications. With some embodiments, the plastic material may be sourced in whole or in part from reground material. Plastic container or jars in accordance with the teachings of this disclosure may be reusable and may, for example, withstand washing cycles of 3 to 30, or more.

Plastic containers formed in accordance with aspects or teachings of the present disclosure may be injection molded and/or formed as a final article without blow molding a preform and without imparting biaxial orientation, such as injection stretch blow molding (ISBM). As such, as used herein a “plastic container” or “injection molded plastic container” as recited herein may also comprise containers or jars formed by other molding processes, such as compression molding, that produce a resultant article without biaxial orientation.

FIG. 3 generally illustrates an embodiment of an injection molded plastic container or jar 10 (which may be referred to herein as a “plastic container” or “plastic container or jar”) with an embodiment of a neck finish portion (also referred to as a neck portion) 20 that includes threads 22. When threads are included with a neck finish 20, such threads (or threading) can involve, inter alia, thread pitch profiles. With embodiment, threads and/or a thread pitch profile may be configured to engage various desired closures. FIG. 4 generally illustrates another embodiment of a plastic container or jar 10 with another embodiment of a neck portion 20 that includes a different configuration of threads 22. Embodiments of a neck portion 20 may be adapted or configured to match/engage standard or conventional closures, including metal closures. Further, as generally illustrated in FIGS. 3 and 4, a plastic container or jar 10 may include an opening 30, a neck portion 20, a body portion 40, and a base portion 44. The base portion 44 may be configured to support the plastic container for standing on a surface. With embodiments, the base portion 44 may include an outer peripheral edge portion (e.g., 46) and a central base portion 48 that extends between the outer peripheral edge portion. In embodiments, a base portion may have a slightly concave profile at its outer peripheral edge portion. Further, the base portion 44 may include reinforcement formations (see, e.g., FIG. 24), which may extend circumferentially or substantially circumferentially around the base portion.

With embodiments of containers 10 such as generally illustrated in FIGS. 3 and 4, the containers may be configured for fill volumes of, for example, 30 ml; may be comprised of PET; and may, for example and without limitation, have an overall empty weight (without closure) of about 20.8±0.13 grams and about 19.0 to 21.0±0.5 grams, respectively. Such containers may further have finish and body weight splits of, for example, about 4.75 grams and about 16.05 grams, and about 4.98 grams and 14.02 grams to about 16.02 grams, respectively. However, embodiments of the disclosure may involve various sized containers, for example and without limitation, containers having a range of 10 ml to 150 ml, ranges of 15 ml to 70 ml, and/or ranges of 25 ml to 50 ml. Weights of such container ranges may be commensurate with respective sizes.

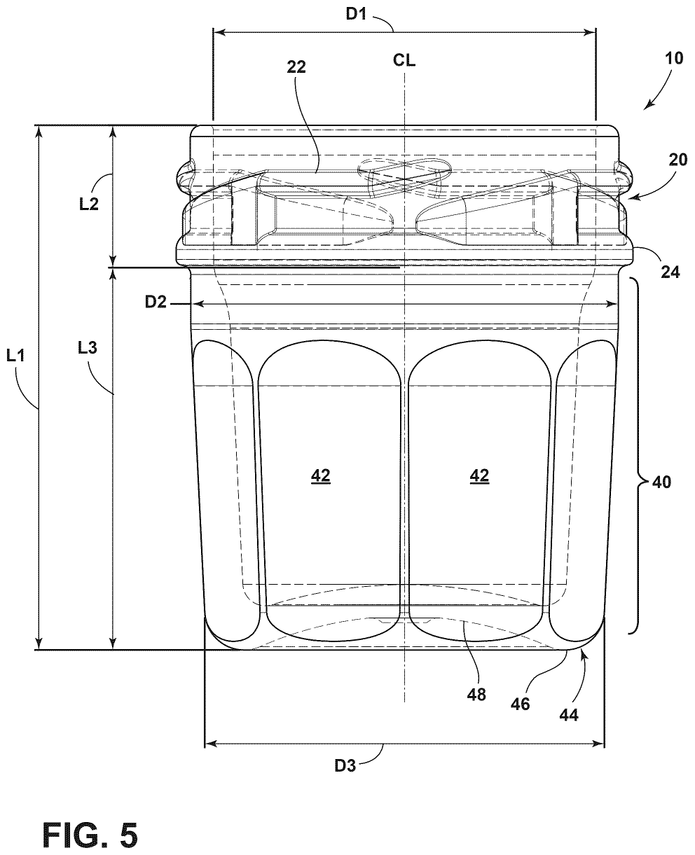

FIG. 5 generally illustrates a side cross-sectional view of the plastic container such as shown in FIG. 4 with an identified centerline CL. The diameter of the container 10 may be different at various vertical positions. For example and without limitation, a first diameter D1, which may be an inner diameter taken at a neck finish position; a second diameter D2, which may be taken at an outer diameter at an upper portion of a body portion 40; and a third diameter D3, which may be an outer diameter taken at a lower portion of a body portion 40. Further, as generally illustrated, a lower portion of the neck finish 20 may include a lower radially extending formation 24 (e.g., a neck ring). With embodiments, a container 10 may have an overall length (or height) L1; a vertical length of a neck finish L2; and a vertical length of a body portion L3. In embodiments that are in the nature of a jar, such as illustrated in FIG. 5, the ratio of an outer diameter of the container (e.g., D2, D3) to the overall length/height of the container (e.g., L1) may be at least about 0.70. In other embodiments the ratio of an outer diameter of the container to the overall length/height of a container 10 may be less than 0.70 or may be at least about 0.75, or even at least about 0.80.

Further with respect to FIG. 5, and for example and without limitation, first diameter D1 may be about 34.00 mm; second diameter D2 may be about 38.00 mm; third diameter D3 may be about 35.51 mm; L1 may be about 46.65 mm; L2 may be about 12.65 mm, and L3 may be about 34.00 mm.

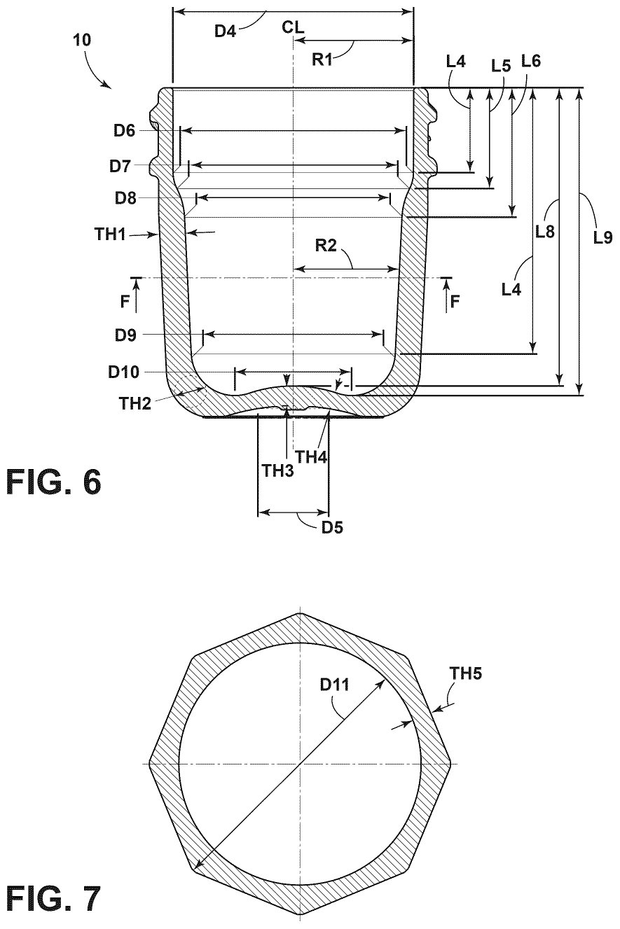

FIG. 6 generally illustrates a side cross-sectional view of an embodiment of a plastic container such as shown in FIG. 4 with an identified centerline CL. FIG. 7 is a top sectional view taken along F-F of FIG. 6. As generally illustrated, body portion may have an octagonal configuration (such as viewed in FIG. 6) and the diameter of the container 10, as well as the wall thickness (TH dimensions), may be different at various positions. With some embodiments, the inclusion of an octagonal shape (e.g., in cross section) in portions in combination with a circular or round shape in other portions may permit reduced wall thickness at least at octagonal panels in the body portion. While octagonal shapes are disclosed, embodiments for various applications may comprise other shapes. Such panels 42 (see, FIG. 5) may serve as vacuum panels, such as in connection with hot-fill or pasteurization. With embodiments of the container, particularly those intended for use with hot-filled or pasteurized contents, the thickness of walls of the container may be configured to be approximately the same as those of a glass container of a similar size and shape that is intended to hold hot-filled or pasteurized contents. With respect to FIGS. 6 and 7, and for example and without limitation, the following may comprise exemplary dimensions:
L4=12.0 mm
L5=14.26 mm
L6=18.3 mm
L7=37.63 mm
L8=42.15 mm
L9=43.5 mm
D4=34.00 mm
D5=10.0 mm
D6=33.94 mm
D7=32.86 mm
D8=30.71 mm
D9=28.82 mm
D10=16.47 mm
D11=33.5 mm
TH1=3.62 mm
TH2=4.5 mm
TH3=2.8 mm
TH4=2.45 mm
TH5=2.35 mm
R1=8.00 mm
R2 generally represents a radius at a lower position of the container, which is typically smaller than a radius in the neck finish portion.

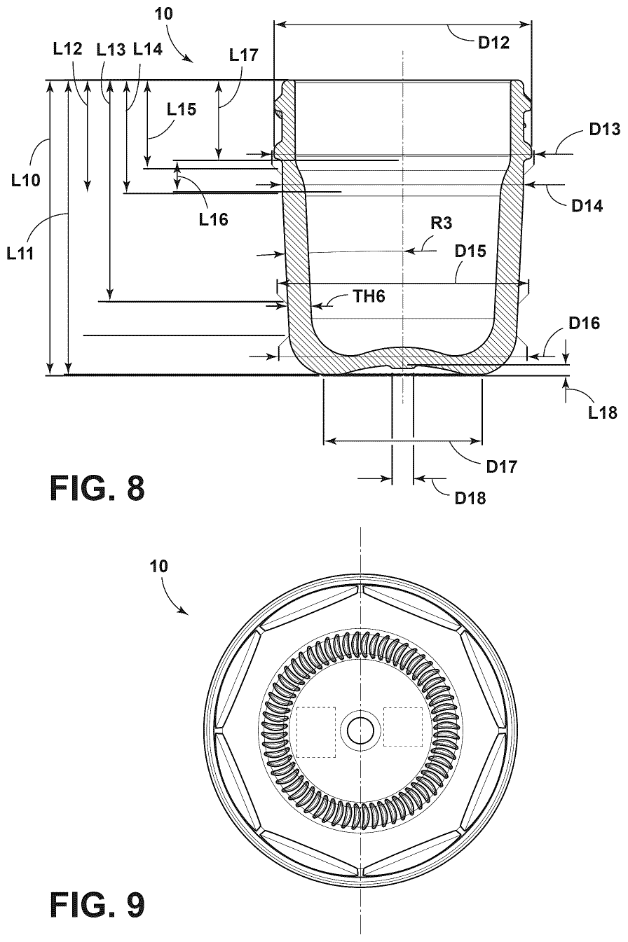

FIG. 8 is another side cross-sectional view of the plastic container generally shown in FIG. 3. With respect to FIG. 8, and for example and without limitation, the following may comprise exemplary dimensions:
L10=46.65 mm
L11=46.45 mm
L12=40.31 mm
L13=35.0 mm
L14=17.89 mm
L15=14.0 mm
L16=5.0 mm
L17=12.65 mm
D12=40.6 mm
D13=38.0 mm
D14=38.0 mm
D15=36.33 mm
D16=35.81 mm
D17=25.0 mm
D18=3.30 mm
TH6=3.63 mm (+/−0.5 mm)

FIG. 9 is a bottom view of the plastic container of the type shown in FIG. 3.

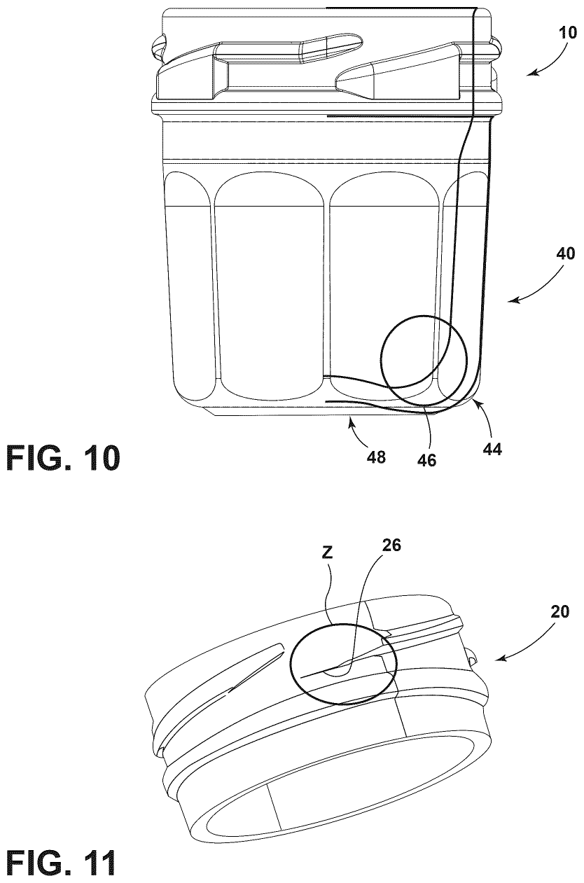

FIG. 10 generally illustrates a side view of an embodiment of a plastic container 10. As generally shown, a base portion 44 may include varying wall thickness and a radiused segment. Moreover, as generally illustrated, lower edge portions 46 of the base portion 44 may be rounded, which may, for example, provide for improved internal removal of contents (e.g., scoop-ability or spoon-ability). FIG. 11 generally illustrates a perspective view of an embodiment of a neck finish portion 20 of a plastic container 10. As generally illustrated, with particular reference to encircled zone Z, a thread end may be provided to minimize a surface of a demolding undercut 26. Configurations of threading to avoid damage because of an undercut can work well.

With embodiments, an injection molded container may have a maximum wall thickness in the neck portion (excluding threading) that is less than the wall thickness of the body portion, the base portion, and both the body portion and the base portion. In embodiments, the greatest wall thickness may be found in the base portion, and may occur in lower edge portions 46 of the base portion 44. In embodiments, the minimum wall thickness of the base portion may be at least 1.09 times the maximum wall thickness of the neck portion (excluding threading); the minimum wall thickness of the base portion may be at least 1.12 times the maximum wall thickness of the body portion; the base portion may have a wall thickness in at least a portion thereof that is more than two times the maximum wall thickness in the neck portion (excluding threading); and/or the body portion may have a wall thickness in at least a portion thereof that is more than 1.43 times the maximum wall thickness in the neck portion (excluding threading).

Further, the base portion 44 may have a varying wall thickness across portions thereof that may decrease radially inward from lower edge portions 46 toward a central vertical axis, and which may then increase (but not to the same extent as the wall thickness in the lower edge portions) at or about a central vertical access, which may coincide with an injection gate.

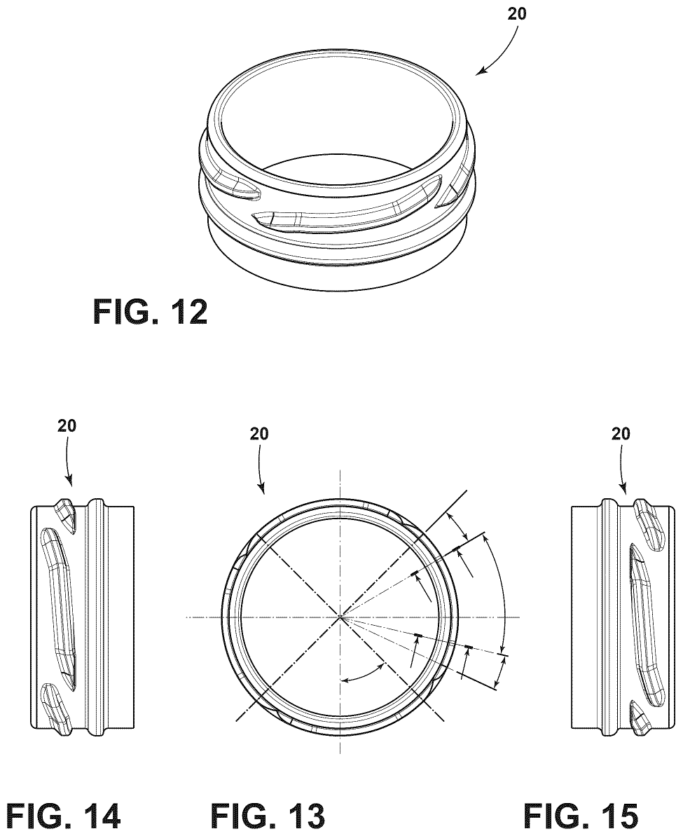

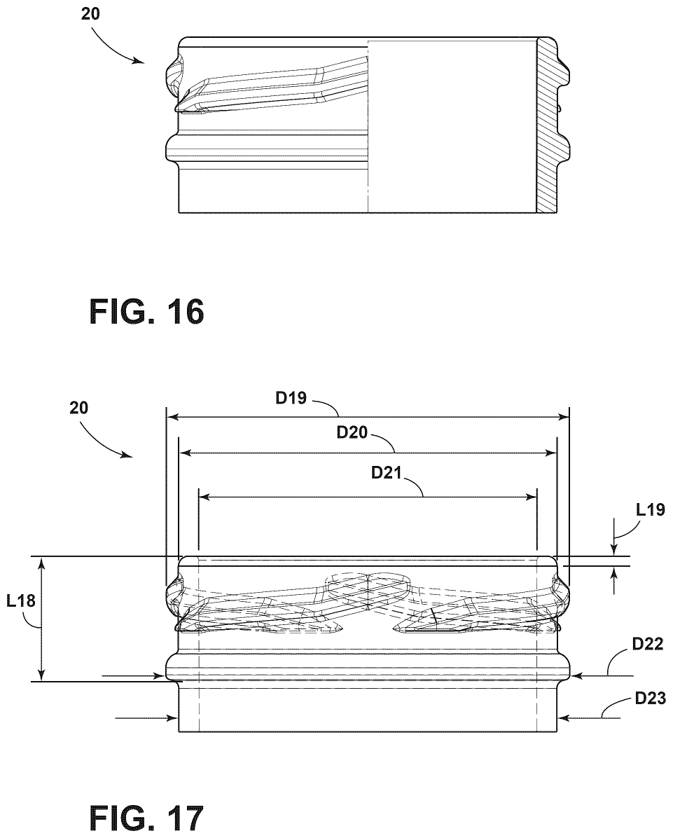

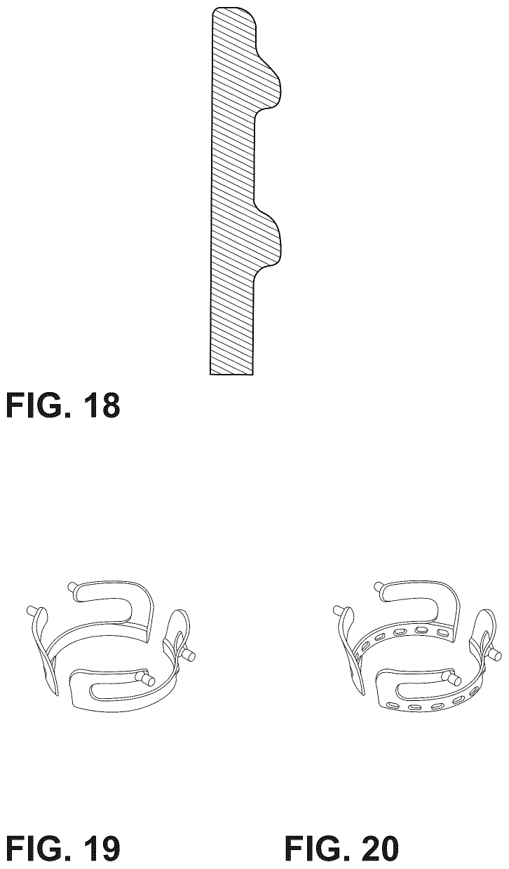

A perspective view of an embodiment of a neck finish portion is generally illustrated in FIG. 12. FIGS. 13, 14, and 15 generally illustrate top and side views, respectively, of a neck finish portion 20. FIG. 16 is a partial side cross-sectional+view of neck finish portion shown in FIG. 12; FIG. 17 is a side (front) view of neck finish portion shown in FIG. 12; and FIG. 18 is side cross-sectional view of the section shown in FIG. 16. With respect to FIG. 17, and for example and without limitation, the following may comprise exemplary dimensions:
L18=12.65 mm (+/−0.25 mm)
L19=1.0 mm
D19=40.5 mm (+/−0.3 mm)
D20=38.05 mm (+/−0.3 mm)
D21=34.0 mm (+/−0.25 mm)
D22=40.6 mm (+/−0.3 mm)
D23=38.0 mm

Embodiments of a core cooling tube (CCT) are generally illustrated in FIGS. 19 and 20. With embodiment, a CCT may be assembled inside a core and may be used to guide cooling water within the CCT. FIG. 19 includes a perspective view representation of an embodiment of a CCT with a single channel. It can involve, for example and without limitation, 3D metal printed neck ring with a taper, which can provide neck ring cooling in the taper. FIG. 20 is a perspective view representation of an embodiment of a CCT with multiple channels. The embodiment in FIG. 20 may also involve, for example and without limitation, a 3D metal printed neck ring that can provide improved neck ring cooling in the taper. In embodiments multiple channel CCTs (e.g., FIG. 20) may include a stronger or more pronounced neck ring taper and, at least in some applications, can provide more stability as compared to a single channel CCT in which a gate may provide a small string and/or may result in significantly more tool cycles before a refurbishing is needed. Embodiments of such plastic containers may be formed by injection molding, and without blow molding.

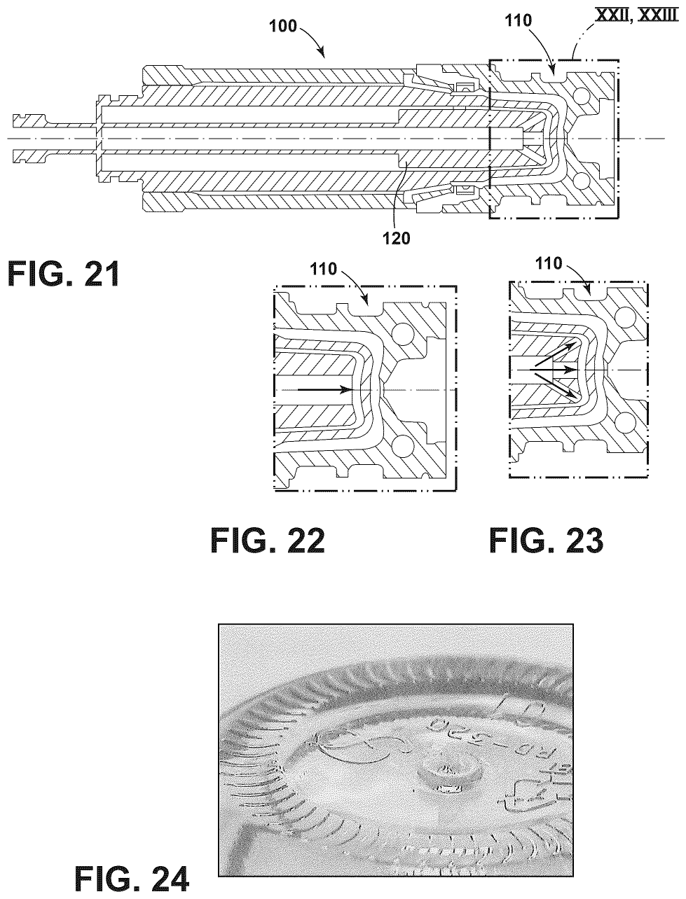

An embodiment of an injection mold 100 is generally illustrated in FIG. 21. In this figure, an embodiment of a CCT is identified as component 120. The injection mold 100 may include a cavity plate 110. FIGS. 22 and 23 generally illustrate enlarged section views of the cavity plate 110 portion identified in FIG. 21. With embodiments, the containers may be designed to be fit into, for example, a small stack injection mold having a 60×140 pitch. With some embodiments of containers 10, such as those illustrated and intended for 30 ml contents, neck ring cooling may not be necessary. Although, in cases where lightweighting may be involved, neck ring cooling may help improve cycle time and/or quality associated with the neck finish.

FIGS. 24 generally illustrates a perspective view of an embodiment of a base portion of a plastic container produced via injection molding.

With embodiments, preform parts may be transferred, for example, from a mold half (e.g., a cold mold half) to a robot or other handling mechanism for further processing and/or handling.

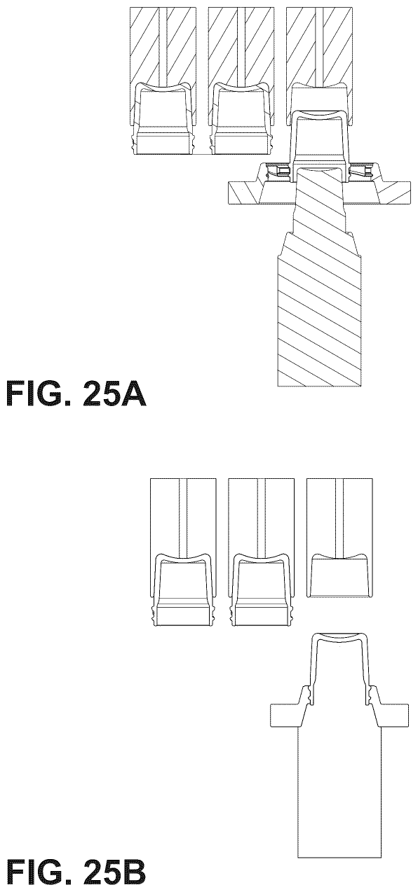

FIGS. 25A and 25B generally illustrate a cross sectional view and a side view representation of embodiments of a system associated with a transfer of an article associated with the present disclosure.

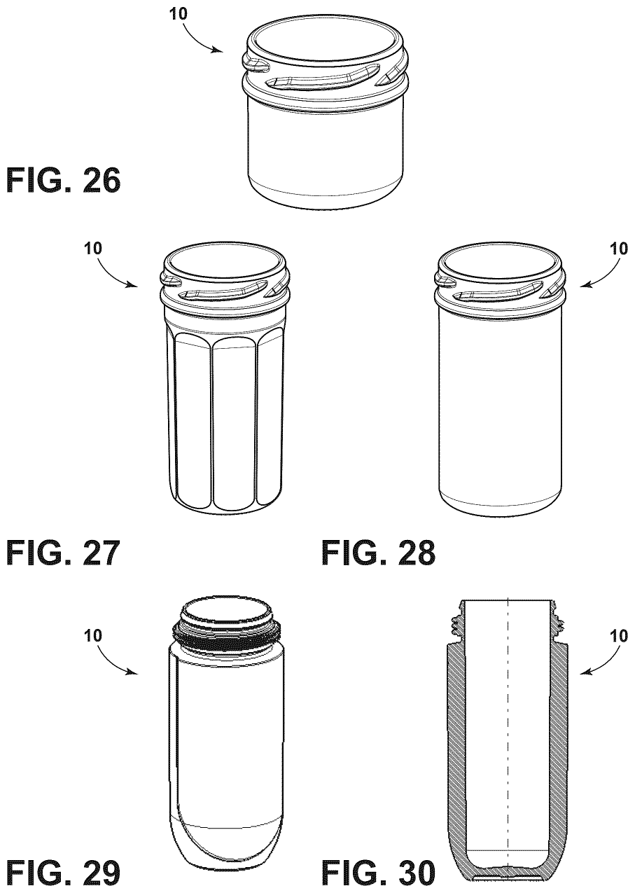

FIGS. 26, 27, and 28 generally illustrate perspective views of other embodiments of plastic containers with different sizes, shapes, and/or features. FIGS. 29 and 30 generally illustrate another embodiment of a plastic container, with FIG. 30 generally illustrating a wall thickness distribution that is shown in cross section. It should be appreciated that the injection molded plastic containers in this disclosure may be provided in various sizes, shapes, dimensions, and configurations without departing from the scope of the invention. The specific examples shown and described herein are for illustrative purposes and should not be construed as limiting.

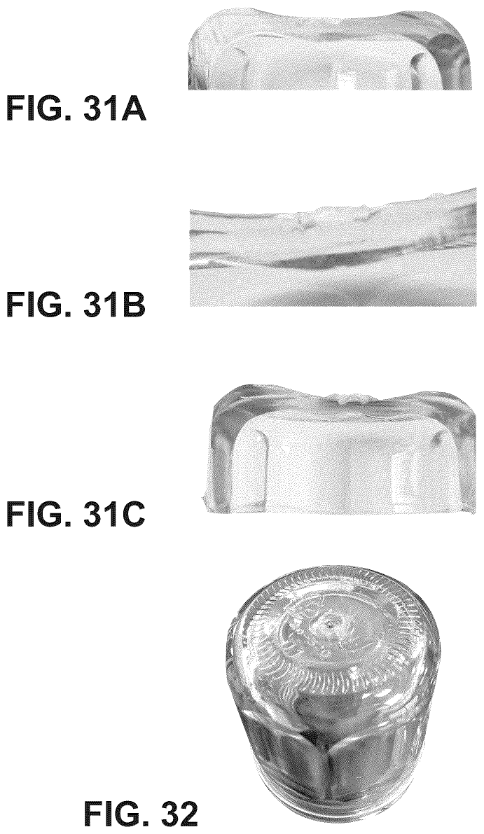

FIGS. 31A, 31B, and 31C generally illustrate cross sectional views of embodiments of base portions of a plastic container according to aspects or teachings of the present disclosure. The base portions shown have undergone post processing after injection. FIG. 32 generally illustrates bottom perspective view of a resultant injection molded plastic container.

With embodiments, the container or jar may be filled at certain temperatures, which may be held for intended or prescribed periods of time. For example, with some embodiments, such a plastic container or jar may be filled with contents at elevated temperature (e.g., 185 F), and may be held for a period of time, such as 5 minutes. With some embodiments of the present disclosure involving robot inserts for base lifting, a cooling time of 6.5 seconds or 5.5 seconds may involve little or no deformation. Moreover, with the utilization of a robot insert for base lifting, a cooling time of as little as 4.5 seconds can provide good base lifting.

With many embodiments involving robot tube inserts, the inserts are not cooled. With such embodiments, such as those which may involve thin-walled articles, a base may be a limiting factor with respect to cycle time. However, with such embodiments or applications cooling may be added to robot tube inserts and can provide significant processing and/or formation improvement.

Production processes, such as those disclosed, may be used to form different articles, including various POTS or final articles. Such processes or methods may, among other things, be employed to ensure base clearances and/or to push the gate inside the base. This can work, inter alia, to minimize base clearance during injection molding without involving additional or extra handling. Further, it is possible, such as via a robot tube, to change a base from a flat base to a base including a dome. Injection of a flat base or a downward extending rounded base may increase stack rigidity, while a base dome (upward extending curve) can be formed in a robot tube with a base shape and a vacuum.

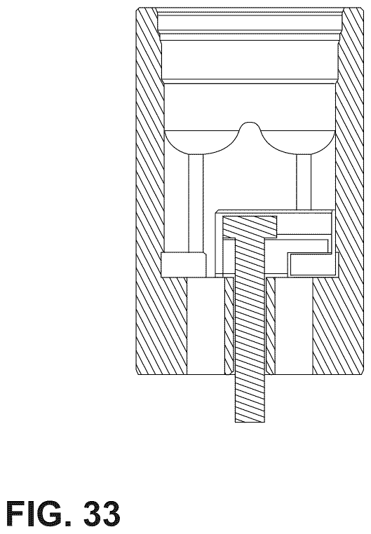

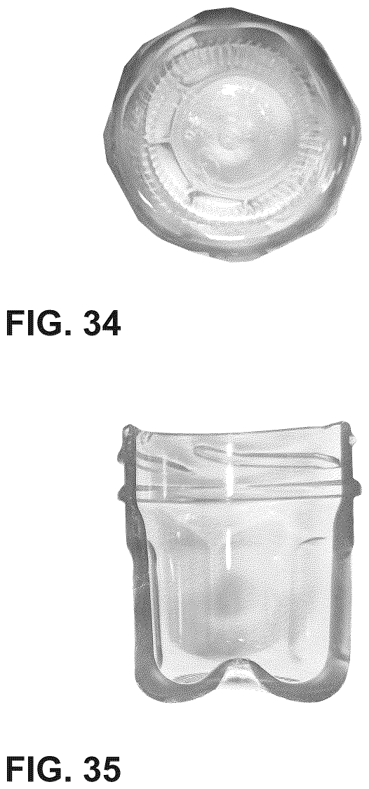

FIG. 33 generally illustrates a cross sectional view of embodiment of a system having a comparatively more extreme stretch robot tube insert, which can form a container or jar having a comparatively extended base dome portion. Top and side views of a container or jar are generally shown in FIG. 34 and FIG. 35, respectively.

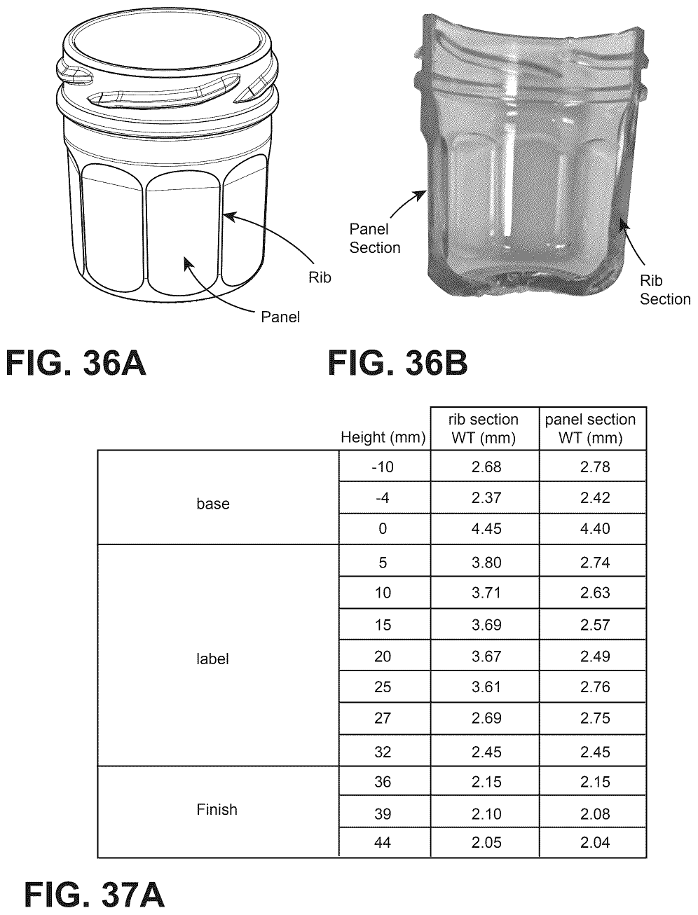

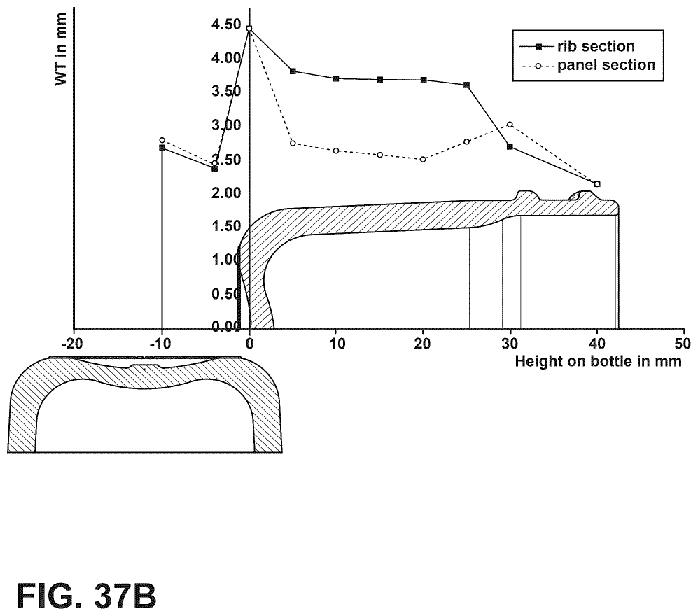

As generally shown in FIG. 36A, an injection molded plastic container or jar may include a plurality of panels separated by a plurality of ribs. FIG. 36B generally illustrates a cross sectional view with panel and rib sections shown. FIG. 37A includes a wall thickness (WT) table. The table identifies wall thickness (in millimeters) in connection with a plastic container with panels such as shown in FIG. 36A. The table in FIG. 37A is broken up into three portions or regions-i.e., a base portion (base), a body portion (label), and a neck portion (finish). The thickness values are provided at various height positions, positive or negative, relative to a zero point between the base portion and body portion. FIG. 37B includes a partial cross sectional illustration of a plastic container and a base portion of a plastic container, along with a wall thickness plot for values associated with both a rib portion and a panel (or body portion).

As generally indicated in the embodiment of the resultant injection molded plastic container associated with FIG. 37A, the greatest thickness value associated with the neck finish (e.g., 2.15 mm) is greater than even the smallest thickness value associated with the body portion (e.g., 2.45 mm) and/or the base portion (e.g., 2.37 mm). Such a configuration is contrasted with injection stretch blow molded containers wherein, for example, thickness values associated with a finish portion of the blown resultant container are significantly greater than thickness values associated with a biaxially stretched and oriented sidewall and/or body portion.

Embodiments of containers or jars, such as disclosed, may further involve a neck finish reverse pre-squaring. With processes, such as hot-filling or pasteurization, a neck finish may shrink and square. However, with some embodiments, the neck finish, or relevant portions of the finish, may be pre-squared—for example, giving a standard diameter at a thread start. As such, it may be possible to apply a closure or cap and increase the diameter where the cap is locked.

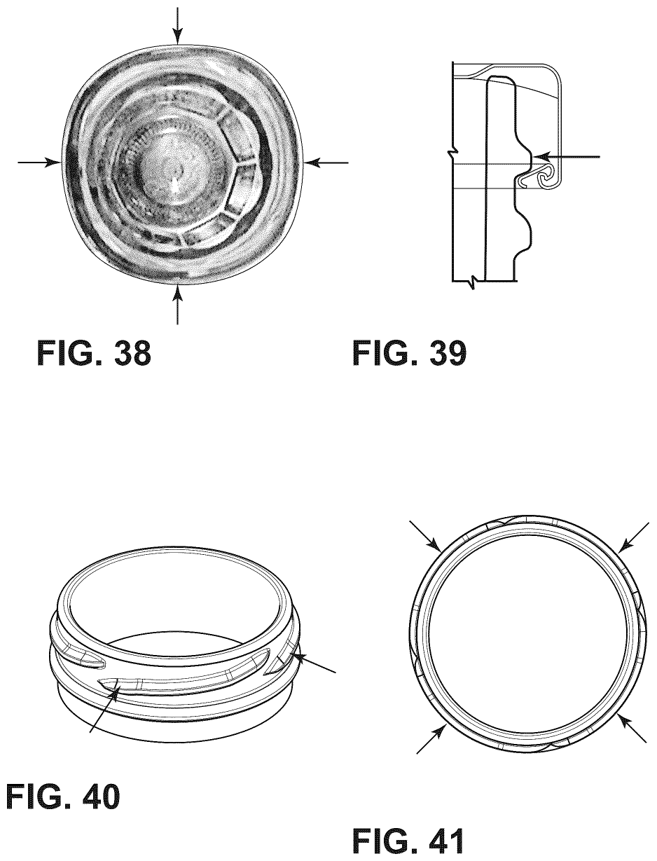

FIG. 38 is a bottom view of an embodiment of a container or jar that generally illustrates squaring associated with four cap lock forces. Such forces are further generally illustrated in connection with FIG. 39 and FIG. 40.

FIG. 41 generally illustrates a reverse pre-squaring. For example and without limitation, as generally illustrated, an E-diameter at tread start may be 38.05 mm (standard). However, an E-diameter at 48 degrees may for example be 40 mm (increased). Among other things, such a pre-squaring associated with a neck finish may improve performance for pasteurization or hot-filling.

The disclosure includes, without limitation, the following embodiments:
1. An injection molded plastic container, comprising: a base portion configured to support the plastic container on a surface, the base portion including an outer peripheral edge portion and a central base portion disposed inwardly from the outer peripheral edge portion; a body portion extending above the base portion, and a neck portion extending above the body portion, the neck portion including a formation configured to receive a cap or closure; wherein the body portion and the base portion are not biaxially oriented; and a wall thickness of the neck portion, excluding the formation, is less than a minimum wall thickness of the base portion.
2. The plastic container of embodiment 1, wherein the formation in the neck portion comprises threading.
3. The plastic container according to any of the preceding embodiments, wherein the container comprises a jar.
4. The plastic container according to any of the preceding embodiments, wherein a ratio of an outer diameter of the container to an overall length/height of the container is about 0.70 or greater.
5. The plastic container according to any of the preceding embodiments, wherein a ratio of an outer diameter of the container to the overall length/height of the container is about 0.75 or greater.
6. The plastic container according to any of the preceding embodiments, wherein a ratio of an outer diameter of the container to the overall length/height of the container is about 0.80 or greater.
7. The plastic container according to any of the preceding embodiments, wherein the wall thickness of the neck portion, excluding the formation, is less than the minimum wall thickness of the body portion.
8. The plastic container according to any of the preceding embodiments, wherein the minimum wall thickness of the base portion is at least 1.09 times a maximum wall thickness of the neck portion, excluding the formation.
9. The plastic container according to any of the preceding embodiments, wherein the minimum wall thickness of the base portion is at least 1.12 times the maximum wall thickness of the body portion.
10. The plastic container according to any of the preceding embodiments, wherein the base portion has a wall thickness in at least a portion thereof that is more than two times the maximum wall thickness in the neck portion, excluding the formation.
11. The plastic container according to any of the preceding embodiments, wherein at least a portion of the body portion has a wall thickness that is more than 1.43 times the maximum wall thickness in the neck portion, excluding the formation.
12. The plastic container according to any of the preceding embodiments, wherein, in cross section, at least a portion of the body portion has a non-circular shape.
13. The plastic container according to any of the preceding embodiments, wherein, in cross section, at least a portion of the body portion has a polygonal shape.
14. The plastic container according to any of the preceding embodiments, wherein, in cross section, at least a portion of the body portion has an octagonal shape.
15. The plastic container according to any of the preceding embodiments, wherein the body portion includes a plurality of panels.
16. The plastic container according to any of the preceding embodiments, wherein each of the plurality of panels is separated by a vertical rib.
17. The plastic container according to any of the preceding embodiments, wherein the base portion has a variable wall thickness.
18. The plastic container according to any of the preceding embodiments, wherein the base portion has a maximum thickness at or about an outer edge portion of the base portion.
19. The plastic container according to any of the preceding embodiments, wherein the central base portion includes a raised central portion.
20. The plastic container according to any of the preceding embodiments, wherein the plastic comprises polyethylene terephthalate (PET).
21. The plastic container according to any of the preceding embodiments, wherein the plastic comprises high-density polyethylene (HDPE).
22. The plastic container according to any of the preceding embodiments, wherein the plastic comprises a multilayer configuration.
23. The plastic container according to any of the preceding embodiments, wherein the multilayer configuration comprises an inner layer of PET, an outer layer of PET, and a layer of PEF therebetween.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such elements. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While examples of dimensions of certain components may be described herein, such dimensions are provided as non-limiting examples and the components may have other dimensions.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. An injection molded plastic container, comprising:
a base portion configured to support the plastic container on a surface, the base portion including an outer peripheral edge portion and a central base portion disposed inwardly from the outer peripheral edge portion;
a body portion extending above the base portion; and
a neck portion extending above the body portion, the neck portion including a formation configured to receive a cap or closure;
wherein the body portion and the base portion are not biaxially oriented; and a wall thickness of the neck portion, excluding the formation, is less than a minimum wall thickness of the base portion.

2. The plastic container of claim 1, wherein the formation in the neck portion comprises threading.

3. The plastic container of claim 1, wherein the plastic container comprises a jar.

4. The plastic container of claim 1, wherein a ratio of an outer diameter of the container to an overall length/height of the container is about 0.70 or greater.

5. The plastic container of claim 1, wherein a ratio of an outer diameter of the container to the overall length/height of the container is about 0.75 or greater.

6. The plastic container of claim 1, wherein a ratio of an outer diameter of the container to the overall length/height of the container is about 0.80 or greater.

7. The plastic container of claim 1, wherein the wall thickness of the neck portion, excluding the formation, is less than the minimum wall thickness of the body portion.

8. The plastic container of claim 1, wherein the minimum wall thickness of the base portion is at least 1.09 times a maximum wall thickness of the neck portion, excluding the formation.

9. The plastic container of claim 1, wherein the minimum wall thickness of the base portion is at least 1.12 times the maximum wall thickness of the body portion.

10. The plastic container of claim 1, wherein the base portion has a wall thickness in at least a portion thereof that is more than two times the maximum wall thickness in the neck portion, excluding the formation.

11. The plastic container of claim 1, wherein at least a portion of the body portion has a wall thickness that is more than 1.43 times the maximum wall thickness in the neck portion, excluding the formation.

12. The plastic container of claim 1, wherein, in cross section, at least a portion of the body portion has a non-circular shape.

13. The plastic container of claim 1, wherein, in cross section, at least a portion of the body portion has a polygonal shape.

14. The plastic container of claim 1, wherein, in cross section, at least a portion of the body portion has an octagonal shape.

15. The plastic container of claim 1, wherein the body portion includes a plurality of panels.

16. The plastic container of claim 15, wherein each of the plurality of panels is separated by a vertical rib.

17. The plastic container of claim 1, wherein the base portion has a variable wall thickness.

18. The plastic container of claim 1, wherein the base portion has a maximum thickness at or about an outer edge portion of the base portion.

19. The plastic container of claim 1, wherein the central base portion includes a raised central portion.

20. The plastic container of claim 1, wherein the plastic comprises polyethylene terephthalate (PET).

21. The plastic container of claim 1, wherein the plastic comprises high-density polyethylene (HDPE).

22. The plastic container of claim 1, wherein the plastic comprises a multilayer configuration.

23. The plastic container of claim 22, wherein the multilayer configuration comprises an inner layer of PET, an outer layer of PET, and a layer of PEF therebetween.
